(19) United States
(12) Patent Application Publication
(10) Pub. No.: US 2026/0284673 A1
(43) Pub. Date: Sep. 24, 2026

(54) SAFETY INTERLOCK SYSTEM FOR INDUSTRIAL MACHINERY

(71) Applicant: Provisur Technologies, Inc., Whitewater, WI (US)

(72) Inventors: Kyle J. Schinkowsky, Tempe, AZ (US); David R. Lee, Janesville, WI (US); Alex E. Robinson, Elkhorn, WI (US); Christopher E. Albrecht, Cambridge, WI (US)

(73) Assignee: Provisur Technologies, Inc., Whitewater, WI (US)

(21) Appl. No.: 19/564,444

(22) Filed: Mar. 12, 2026

Related U.S. Application Data
(60) Provisional application No. 63/774,478, filed on Mar. 19, 2025.

(51) Int. Cl. B02C 23/04; F16P 3/08

(52) U.S. Cl. CPC B02C 23/04; F16P 3/08

(57) ABSTRACT

A safety interlock system includes a prime mover, a working member, a guard assembly, a mode switch, and an interlock sensor. The prime mover is operable to provide rotational driving force to the working member. The guard assembly is moveable between a closed position, in which the guard assembly at least partially covers the working member, and an open position that affords access to the working member. The mode switch is operable to control the prime mover between an ON state and an OFF state. The interlock sensor is operable to detect movement of the prime mover. Regardless of whether the prime mover is in the ON state or the OFF state, the interlock sensor prevents movement of the guard assembly away from the closed position when movement of the prime mover is detected.

### CROSS-REFERENCE TO RELATED APPLICATIONS

This application claims the benefit of priority under 35 U.S.C § 119(e) to U.S. Provisional Patent Application No. 63/774,478, filed on Mar. 19, 2025, and titled “SAFETY INTERLOCK SYSTEM FOR INDUSTRIAL MACHINERY,” the entire contents of which are hereby incorporated by reference in their entirety.

### TECHNICAL FIELD

This disclosure relates to a safety interlock system for industrial machinery, and, for example, to a safety interlock system that inhibits access to moving parts within an industrial meat grinder.

### BACKGROUND

An industrial meat grinder is a type of machine that is used to efficiently convert a large cut of meat into a ground or minced form that is suitable for various culinary applications. The industrial meat grinder includes a meat-processing section and a main body section, both of which may include moving parts that pose a safety hazard to individuals operating the industrial meat grinder.

The meat-processing section includes an upper funnel, which may be referred to as a hopper, an orifice plate, and a head that connects the upper funnel to the orifice plate. The upper funnel includes an opening for receiving the large cut of meat. The orifice plate includes a plurality of holes through which the meat is configured to be extruded in the ground or minced form. The head includes a passage that fluidly communicates with the opening and the plurality of holes and that includes feedscrew and a blade therein. The feedscrew is configured to push the meat within the passage toward the orifice plate, and the blade is configured to co-rotate with the feedscrew to cut the meat prior to extrusion. In some cases, an operator may access at least one of the feedscrew and the blade from an exterior of the meat-processing section through the plurality of holes of the orifice plate.

The main body section includes a housing that supports the meat-processing section and that houses, among other components, a prime mover and one or more belts, which are configured to drive rotation of the feedscrew and the blade. In some cases, an operator may access the prime mover and the one or more belts via one or more doors in the housing.

While best practices may be employed to shut down the industrial meat grinder and/or inhibit access to moving parts therein (e.g., the feedscrew, the blade, the prime mover, and the one or more belts), an operator may experience a false sense of security due to a delay between the shut down of the industrial meat grinder and actual stoppage of all the moving parts. In other words, there may be a risk that an operator reaches into the industrial meat grinder—either through a hole in the orifice plate or the one or more doors in the house—after shut down but while the moving parts have not yet stopped moving, therefore creating a risk of harm to the operator and/or the industrial meat grinder.

The safety interlock system of the present disclosure solves one or more of the problems set forth above and/or other problems in the art.

### SUMMARY

In some aspects, a safety interlock system for industrial machinery is provided. The safety interlock system includes a prime mover, a working member, a guard assembly, a latch, a locking member, a mode switch, and an interlock sensor. The prime mover is operable to provide rotational driving force. The working member is driven by the prime mover. The guard assembly is moveable between a closed position, in which the guard assembly at least partially covers the working member, and an open position that affords access to the working member. The latch is engageable with the guard assembly and moveable between a latched position that secures the guard assembly in the closed position and a release position that affords movement of the guard assembly toward the open position. The locking member is engageable with the latch. The locking member has a locked configuration that secures the latch in the latched position, and an unlocked configuration that affords movement of the latch from the latched position toward the release position. The mode switch is operable to control the prime mover between an ON state and an OFF state. The interlock sensor is operable to detect movement of at least one of the prime mover and the working member. Regardless of whether the prime mover is in the ON state or the OFF state, the interlock sensor prevents the locking member from changing state from the locked configuration when movement of at least one of the prime mover and the working member is detected.

The prime mover may include an electric motor. The interlock sensor may include a current sensor in electrical communication with the electric motor. The current sensor may be operable to sense induced electrical current resulting from the rotational movement of the electric motor after the electric motor has been changed from the ON state to the OFF state. The interlock sensor may include a rotatory sensor that is operable to sense rotational movement of at least one component of at least one of the prime mover and the working member. The working member may include at least one of a feedscrew and a blade.

The latch may include a first end, a second end, and a pivot axis. The first end may be engageable with the guard assembly, and the second end may be engageable with the locking member. The latch may be pivotable about the pivot axis between the latched position and the release position. The guard assembly may include a mounting arm having a pin extending transversely therethrough. The first end of the latch may include a slot that is sized to receive the pin. Upon movement of the guard assembly from the open position toward the closed position, the pin may engage the slot and urge the latch from the release position toward the latched position. Engagement of the pin with the slot may limit rotational movement of the guard assembly about the mounting arm to at least partially secure the guard assembly in the closed position. When the guard assembly is in the closed position, the latch is in the latched position, and the locking member is in the locked configuration, the locking member may prevent pivotal movement of the latch about the pivot axis.

The locking member may include a proximity sensor and an electromagnet. The proximity sensor may be operable to detect when the latch is in the latched position. When the locking member is in the locked configuration, the locking member may energize the electromagnet to secure the latch in the latched position. The locking member may include one of an electromagnet and a solenoid component. When the locking member is in the locked configuration, the locking member may energize the one of the electromagnet and the solenoid component to secure the latch in the latched position. The prime mover, the latch, and the locking member may be contained within a housing.

In other aspects, a safety interlock system for industrial machinery is provided. The safety interlock system includes a prime mover, a working member, a guard assembly, a mode switch, and an interlock sensor. The prime mover is operable to provide rotational driving force. The working member is driven by the prime mover. The guard assembly is moveable between a closed position, in which the guard assembly at least partially covers the working member, and an open position that affords access to the working member. The mode switch is operable to control the prime mover between an ON state and an OFF state. The interlock sensor is operable to detect movement of at least one of the prime mover and the working member. Regardless of whether the prime mover is in the ON state or the OFF state, the interlock sensor prevents movement of the guard assembly away from the closed position when movement of at least one of the prime mover and the working member is detected.

The prime mover may include an electric motor. The interlock sensor may include a current sensor in electrical communication with the electric motor. The current sensor may be operable to sense induced electrical current resulting from rotational movement of the electric motor after the electric motor has been changed from the ON state to the OFF state. The working member may include at least one of a feedscrew and a blade. The interlock sensor may include a rotary sensor that is operable to sense rotational movement of at least one component of at least one of the prime mover and the working member. The safety interlock system may further include a housing that contains the prime mover and isolates the prime mover from the working member and the guard assembly. The guard assembly may include a pair of guards and a pair of mounting blocks. The pair of guards may each include a shielding component and a mounting arm. The shielding component may be configured to at least partially cover the working member, and the mounting arm may support the shielding component. The pair of mounting blocks may be attached to the housing and may each include a receptacle to receive a distal end of a respective mounting arm. The safety interlock system may further include a pair of locking mechanisms. Each locking mechanism may include a latch that is configured to engage the distal end of the respective mounting arm to secure the guard assembly in the closed position.

In other aspects, a safety interlock system for industrial machinery is provided. The safety interlock system may include a prime mover, a working member, a guard assembly, a latch, and an interlock sensor. The prime mover may be operable to provide rotational driving force. The working member may be driven by the prime mover. The guard assembly may be moveable between a closed position, which in which the guard assembly inhibits access to the working member, and an open position that affords access to the working member. The latch may be engageable with the guard assembly and moveable between a latched position that secures the guard assembly in the closed position, and a release position that affords movement of the guard assembly toward the open position. The interlock sensor may be operable to detect movement of at least one of the prime mover and the working member. The interlock sensor may prevent the guard assembly from moving to the open position when movement at least one of the prime mover and the working member is detected.

The safety interlock system may further include a mode switch. The mode switch may be operable to control the prime mover between an ON state and an OFF state. The interlock sensor may be configured to prevent the guard assembly from moving to the open position when movement of the at least one of the prime mover and the working member is detected, regardless of whether the prime mover is in the ON state or the OFF state. The prime mover may be an electric motor, and the working member may be a feedscrew. The guard assembly may include a mounting arm having a pin extending transversely therethrough. The latch may include a first end and a second end. The first end may be engageable with the guard assembly and may include a slot that is sized to receive the pin. The second end may be opposite the first end. Upon movement of the guard assembly from the open position to toward the closed position, the pin may engage the slot and urge the latch from the release position toward the latched position. The safety interlock system may further include a locking member engageable with the second end of the latch. The locking member may have a locked configuration that secures the latch in the latched position, and an unlocked configuration that affords movement of the latch from the latched position toward the release position.

In other aspects, a safety interlock system for industrial machinery is provided. The safety interlock system includes a prime mover, a working member, a guard assembly, a latch, a locking member, a housing, a mode switch, and an interlock sensor. The prime mover includes an electric motor that is operable to provide rotational driving force. The working member is driven by the prime mover and includes a feedscrew. The guard assembly is moveable between a closed position, in which the guard assembly inhibits access to the feedscrew, and an open position that affords access to the feedscrew. The guard assembly includes a mounting arm having a pin extending transversely therethrough. The latch is engageable with the guard assembly and is moveable between a latched position that secures the guard assembly in the closed position and a release position that affords movement of the guard assembly toward the open position. The latch includes a first end, a second end opposite the first end, and a pivot axis about which the latch is pivotable between the latched position and the release position. The first end is engageable with the guard assembly and includes a slot that is sized to receive the pin. Upon movement of the guard assembly from the open position toward the closed position, the pin engages the slot and urges the latch from the release position toward the closed position. Engagement of the pin with the slot limits rotational movement of the guard assembly about the mounting arm to at least partially secure the guard assembly in the closed position. The locking member is engageable with the second end of the latch. The locking member has a locked configuration that secures the latch in the latched position, and an unlocked configuration that affords movement of the latch from the latched position toward the release position. The locking member includes a proximity sensor and an electromagnet. The proximity sensor is operable to detect when the latch is in the latched position. When the locking member is in the locked configuration, the locking member energizes the electromagnet to secure the latch in the latched position. The housing contains the prime mover, the latch, and the locking member. The mode switch is operable to control the prime mover between an ON state and an OFF state. The interlock sensor includes a current sensor in electrical communication with the electric motor. The current sensor is operable to sense induced electrical current resulting from rotational movement of the electric motor after the electric motor has been changed from the ON state to the OFF state. When the guard assembly is in the closed position, the latch is in the latched position, and the locking member is in the locked configuration, the locking member prevents pivotal movement of the latch about the pivot axis. Regardless of whether the prime mover is in the ON state or the OFF state, the interlock sensor prevents the locking member from changing state from the locked configuration to the unlocked configuration when movement of the electric motor is detected.

### BRIEF DESCRIPTION OF DRAWINGS

FIG. 1 is a side view of an example industrial meat grinder having a guard assembly, in accordance with one or more aspects of the present disclosure.

FIG. 2 is an isometric view of the industrial meat grinder of FIG. 1 with the guard assembly in a closed position, in accordance with one or more aspects of the present disclosure.

FIG. 3 is an opposing isometric view of the industrial meat grinder of FIG. 1 with the guard assembly in the closed position, in accordance with one or more aspects of the present disclosure.

FIG. 4 is an isometric view of the guard assembly of FIG. 1 in an open position, in accordance with one or more aspects of the present disclosure.

FIG. 5 is a cross-sectional view of a front locking mechanism of the industrial meat grinder of FIG. 1 in an unlocked configuration, in accordance with one or more aspects of the present disclosure.

FIG. 6 is a cross-sectional view of the front locking mechanism of FIG. 5 in a locked configuration, in accordance with one or more aspects of the present disclosure.

FIG. 7 is a rear isometric view of a portion of the industrial meat grinder of FIG. 1 with rear doors in closed positions, in accordance with one or more aspects of the present disclosure.

FIG. 8 is a rear view of the industrial meat grinder of FIG. 1 with the rear doors in open positions, in accordance with one or more aspects of the present disclosure.

FIG. 9 is an isometric view of a portion of the industrial meat grinder of FIG. 1 with one rear door in a closed position and another rear door in an open position, in accordance with one or more aspects of the present disclosure.

FIG. 10 is an isometric view of an alternative front locking mechanism in an unlocked configuration, in accordance with one or more aspects of the present disclosure.

Before any exemplary configurations of the disclosure are explained in detail, it is to be understood that the disclosure is not limited in its application to the details of construction and the arrangement of components set forth in the following description or illustrated in the accompanying drawings. The disclosure is capable of other configurations and of being practiced or of being carried out in various ways. Also, it is to be understood that the phraseology and terminology used herein is for the purpose of description and should not be regarded as limiting.

### DETAILED DESCRIPTION

This disclosure relates to a safety interlock system. In the description that follows, the safety interlock system will be described in relation to an example industrial meat grinder. However, it should be understood that the safety interlock system is applicable to any type of machinery that includes parts therein that, due to the principle of inertia, may continue to move for a time period after the machinery has been shut down.

To simplify explanation below, the same reference characters may be used to denote like features. The drawings may not be to scale.

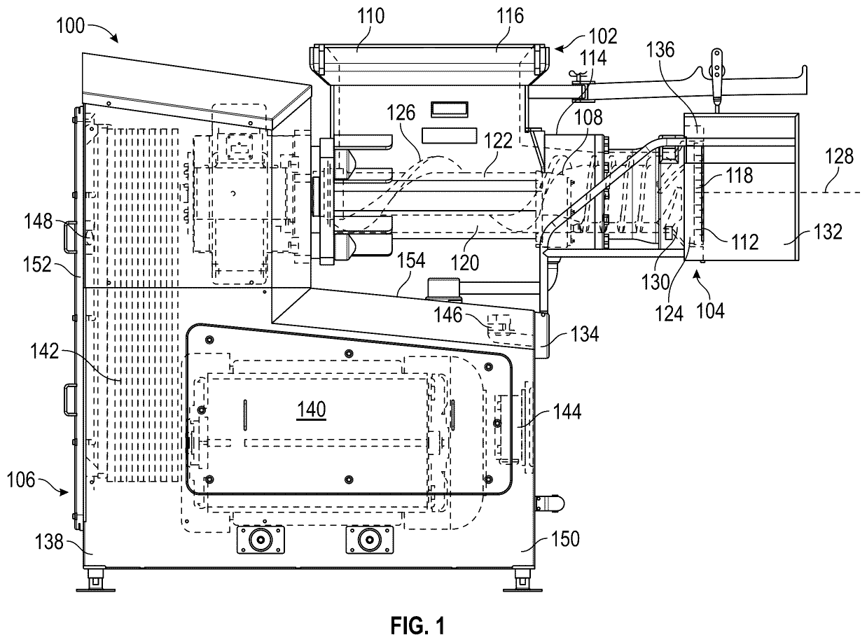

FIG. 1 illustrates an example industrial meat grinder 100. The industrial meat grinder 100 includes a meat-processing section 102, a guard assembly 104, a main body section 106, and a mode switch 108. The meat-processing section 102 includes an upper funnel 110, which may be referred to herein as a hopper, an orifice plate 112, and a head 114 that connects the upper funnel 110 to the orifice plate 112. The upper funnel 110 is a tapered component that includes an opening 116 for receiving a large cut of meat (e.g., beef, pork, lamb, poultry, and/or the like). The orifice plate 112 is a substantially planar component that includes a plurality of holes 118 through which the meat is configured to be extruded in ground or minced form. The head 114 is a hollow component that includes a passage 120 that fluidly communicates with the opening 116 and the plurality of holes 118 and that includes a feedscrew 122 and a blade 124, which may be referred to elsewhere herein—either individually or collectively—as a working member. The feedscrew 122 includes a helical thread 126 that is configured to push the meat within the passage 120 toward the orifice plate 112 as the feedscrew 122 rotates about a longitudinal axis 128. The blade 124, which may be a four-winged blade, a star blade, and/or the like, is mounted to a distal end 130 of the feedscrew 122 and is configured to co-rotate therewith about the longitudinal axis 128 to cut the meat prior to extrusion.

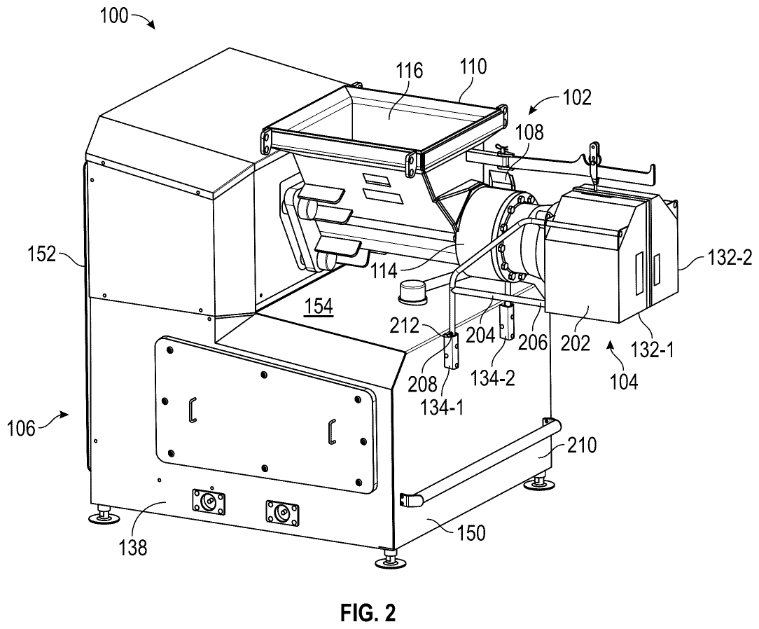

The guard assembly 104 is a set of safety components that are configured to inhibit access to the feedscrew 122 and/or the blade 124 via the plurality of holes 118 in the orifice plate 112. The guard assembly 104 includes a pair of guards 132, which include a first guard 132-1 and a second guard 132-2 (shown in FIGS. 2-4), and a corresponding pair of mounting blocks 134, which likewise include a first mounting block 134-1 and a second mounting block 134-2 (also shown in FIGS. 2-4). The pair of guards 132 are configured to selectively cover a distal end 136 of the head 114 and the orifice plate 112. Further details regarding the guard assembly 104 will be provided below in connection with FIGS. 2-4.

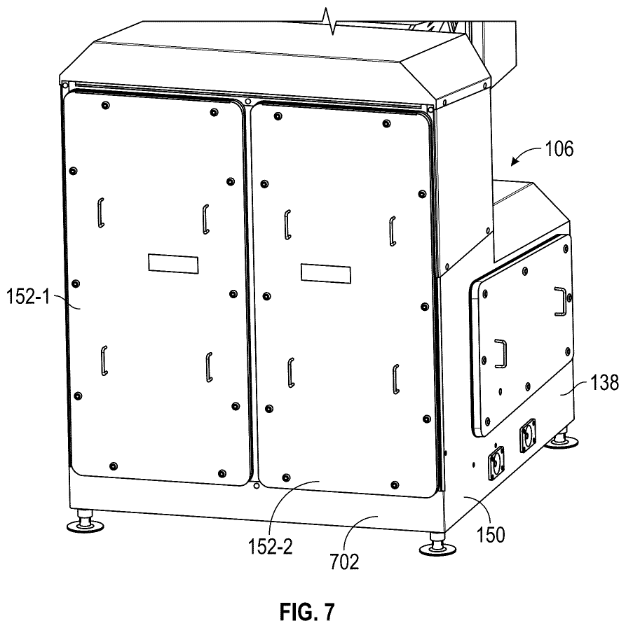

The main body section 106 includes a housing 138 that supports the meat-processing section 102 and that houses, among other components, a prime mover 140, one or more belts 142, an interlock sensor 144, a pair of front locking mechanisms 146, and a pair of rear locking mechanisms 148. The housing 138 is a hollow structure that includes a frame 150 and a pair of rear doors 152 hingedly attached thereto. Further details regarding the pair of rear doors 152, which include a first rear door 152-1 and a second rear door 152-2, will be provided below in connection with FIGS. 7-9.

The prime mover 140 is a machine that converts one type of energy (e.g., electrical energy, chemical energy, and/or the like) into mechanical work. The prime mover 140, which may be an electric motor, an internal combustion engine, and/or the like, engages the one or more belts 142 to provide rotational driving force to the feedscrew 122 (and as a result, to the blade 124, which is attached to the feedscrew 122). The one or more belts 142 are flexible loops of material that may directly engage or indirectly engage (e.g., via one or more intermediate components, such as a pulley) the feedscrew 122 to transfer motion from the prime mover 140 to the feedscrew 122.

The interlock sensor 144 is a device that is configured to detect movement of the prime mover 140 and/or another component within the industrial meat grinder 100 (e.g., the feedscrew 122, the blade 124, and/or the like). For example, when the prime mover 140 is an electric motor, the interlock sensor 144 may include a current sensor that is in electrical communication with the electric motor and is configured to sense induced electrical current resulting from rotational movement of the electric motor. As another example, the interlock sensor 144 may include a rotary sensor that is configured to sense rotational movement of at least one component, such as the prime mover 140, the feedscrew 122, a pulley that guides the one or more belts 142, and/or the like).

In the illustrated configuration, the prime mover 140 includes a 3-phase electric motor and the interlock sensor 144 may be a speed monitoring specialty safety relay, such as model number 440R-S35011, available from ROCKWELL AUTOMATION®. This exemplary interlock sensor 144 includes a three phase input, and is configured such that one input lead may be electrically coupled to each phase of the power supply to the prime mover 140. The exemplary interlock sensor 144 also includes at least one output that may be wired in series, either directly or via an appropriate relay or other signal transfer mechanism, to one or more safety interlock circuits of the industrial meat grinder 100. The interlock sensor 144 may be configured such that when electrical current is detected in the power supply leads for the prime mover 140, the interlock sensor 144 output remains in a condition (e.g. an open state or a closed state) that causes the pair of front locking mechanisms 146 and the pair of rear locking mechanisms 148 to remain in their respective locked configurations, as discussed further below. In operation, the interlock sensor 144 may detect current resulting from either i) electrical power being supplied to the prime mover 140, or ii) back current generated in the prime mover 140 power supply leads resulting from back-electromotive force as the prime mover 140 and other rotating components of the industrial meat grinder 100 slow to a complete stop after electrical power to the prime mover 140 has been turned off. In this way, the interlock sensor 144 maintains its output in a configuration that keeps the pair of front locking mechanisms 146 and the pair of rear locking mechanisms 148 in their respective locked configurations 1) during prime mover 140 operation and 2) during the time it takes for the prime mover 140 and other rotating components of the industrial meat grinder 100 to stop rotating after electrical power to the prime mover 140 has been turned off.

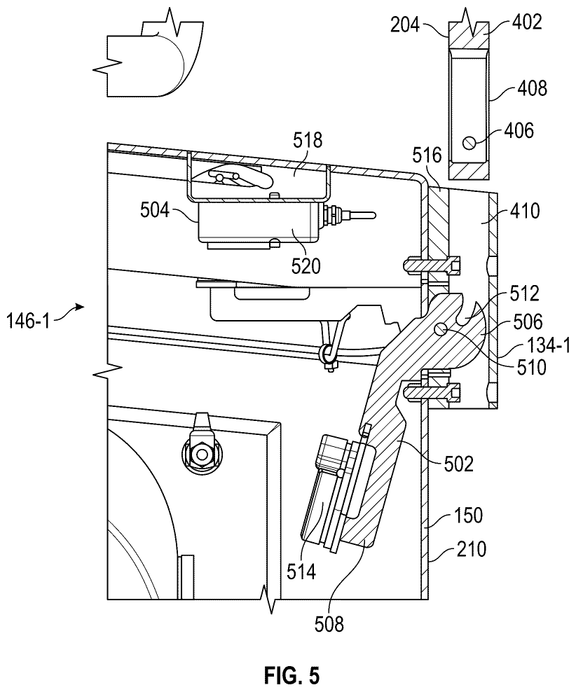

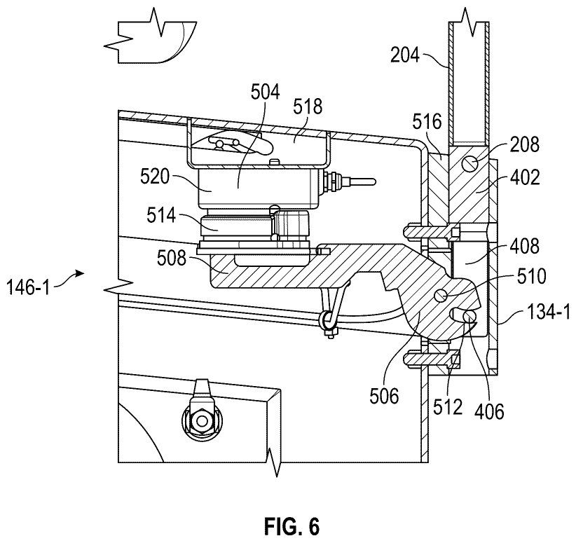

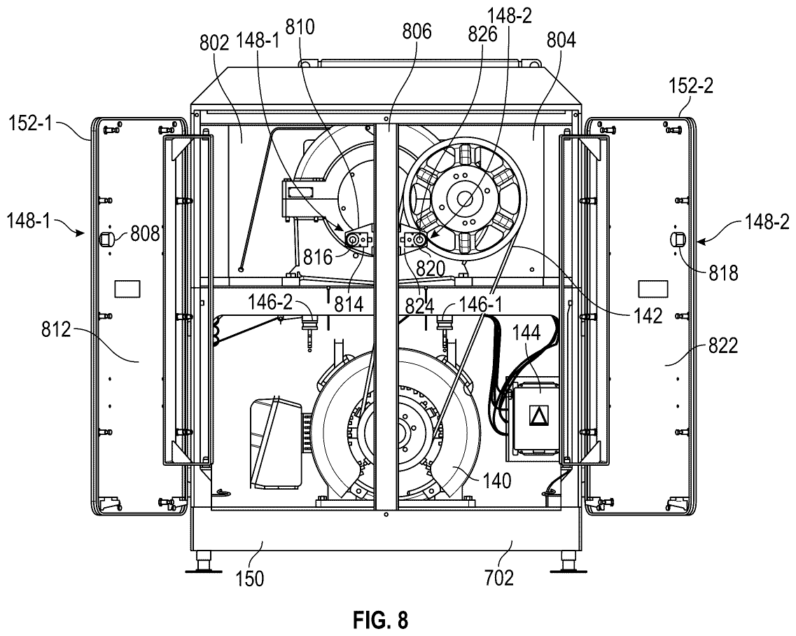

The pair of front locking mechanisms 146 and the pair of rear locking mechanisms 148 are mechanisms that are configured to selectively inhibit access to the industrial meat grinder 100 based on the output signal or instruction from the interlock sensor 144 associated with detected movement of one or more components (e.g., the prime mover 140, the feedscrew 122, the blade 124, and/or the like). In particular, the pair of front locking mechanisms 146, which include a first front locking mechanism 146-1 and a second front locking mechanism 146-2, are configured to selectively lock the guard assembly 104 in a closed position to prevent an operator from accessing the feedscrew 122 and/or the blade 124 during movement thereof. The pair of rear locking mechanisms 148, which include a first rear locking mechanism 148-1 and a second rear locking mechanism 148-2, are configured to selectively lock the pair of rear doors 152 in a closed position to prevent an operator from accessing the one or more belts 142 and/or other components within the housing 138 during movement thereof. Further details regarding the pair of front locking mechanisms 146 will be provided below in connection with FIGS. 5-6. Further details regarding the pair of rear locking mechanisms 148 will be provided below in connection with FIGS. 7-8.

The mode switch 108, also illustrated in FIG. 2, is a device that is configured to selectively provide electrical energy to the prime mover 140 to control the prime mover 140 between an ON state (in which electrical energy is supplied to the prime mover 140) and an OFF state (in which electrical energy is not supplied to the prime mover 140). The mode switch 108 may be mounted to an exterior surface of the industrial meat grinder 100. For example, the mode switch 108 may mounted to an upper panel 154 of the frame 150. Other locations and types of mode switches are possible.

Because the combination of components set forth above prevents access to an interior of the industrial meat grinder 100 whenever there is detected movement inside the industrial meat grinder 100 (and regardless of whether the mode switch 108 is in a state that provides electrical energy or not), the combination of components mitigate the safety hazard associated with the inertial delay between the halting of supply of the electrical energy (via the mode switch 108) to the prime mover 140 and the halting of component movement within the industrial meat grinder 100.

As indicated above, FIG. 1 is provided as an example. Other examples may differ from what is described with regard to FIG. 1. For example, the number and arrangement of components may differ from that shown in FIG. 1. Thus, there may be additional components, fewer components, different components, differently shaped components, differently sized components, and/or the like. For example, in some implementations, the industrial meat grinder 100 may not include the blade 124.

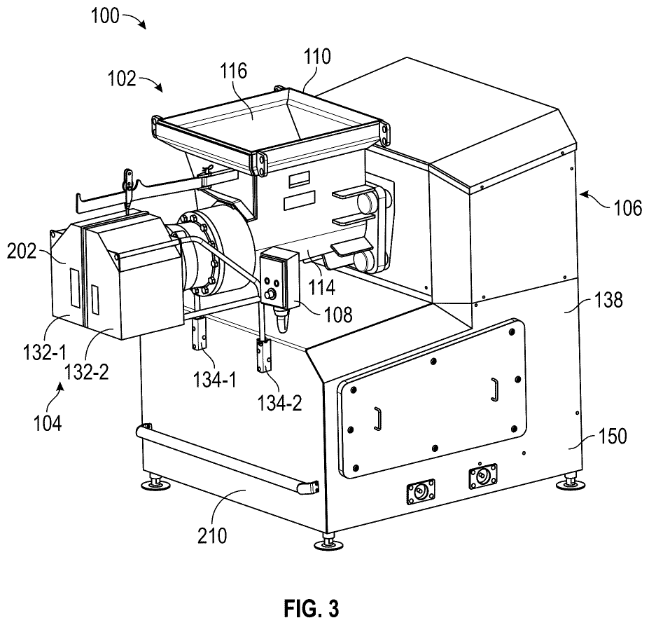

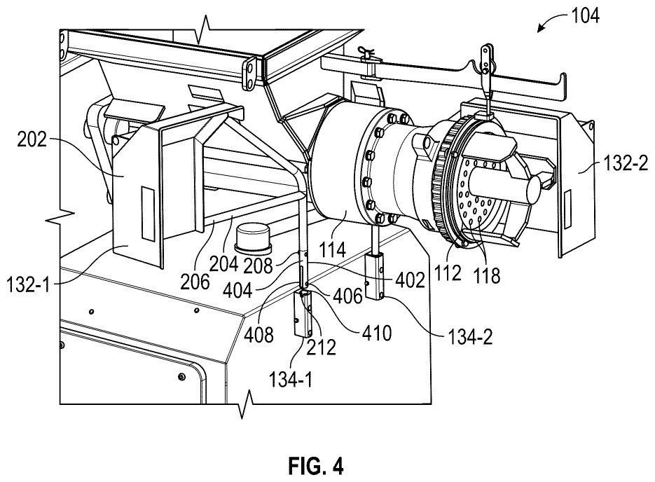

FIGS. 2-4 illustrate the guard assembly 104. FIGS. 2-3 illustrate the guard assembly 104 in a closed position, with the first guard 132-1 and the second guard 132-2 both in closed positions. FIG. 4 illustrates the guard assembly 104 in a partially open position, with the first guard 132-1 in an open position and the second guard 132-2 in a closed position. In the description that follows, the first guard 132-1 and the first mounting block 134-1 will be described. With the exception that the first guard 132-1 and the first mounting block 134-1 are oppositely configured relative to the second guard 132-2 and the second mounting block 134-2, it should be understood that the description equally applies to the second guard 132-2 and the second mounting block 134-2. In other words, the first guard 132-1 is a mirror image of the second guard 132-2, and the first mounting block 134-1 is a mirror image of the second mounting block 134-2.

The first guard 132-1 includes a shielding component 202 and a mounting arm 204. The shielding component 202 is a concave structure that is shaped and sized to cover a half of the distal end 136 of the head 114 and a half of the orifice plate 112. The mounting arm 204 is a support structure that includes a proximal end portion 206 and a distal end portion 402 (shown in FIG. 4). The proximal end portion 206 is attached to the shielding component 202. The distal end portion 402, which extends in a direction that is substantially perpendicular to the proximal end portion 206, includes an upper protrusion 208 and a lower pin 406. The upper protrusion 208 extends from an exterior 404 of the distal end portion 402. The lower pin 406 extends transversely, and in a direction that is parallel to the upper protrusion 208, through a slot 408 that is formed in the distal end portion 402.

The first mounting block 134-1 is mounted to a front panel 210 of the frame 150 and includes a receptacle 410 having an upper notch 212. The receptacle 410, which communicates with the first front locking mechanism 146-1 (as will be described below), is configured to receive the distal end portion 402 of the mounting arm 204 to allow the distal end portion 402 to engage the first front locking mechanism 146-1. The upper notch 212 is configured to receive the upper protrusion 208 of the distal end portion 402 when the first guard 132-1 is in the closed position to ensure proper alignment of the first guard 132-1 with the first mounting block 134-1, which in turn positions the shielding component 202 over the distal end 136 of the head 114.

As indicated above, FIGS. 2-4 are provided as an example. Other examples may differ from what is described with regard to FIGS. 2-4. For example, the number and arrangement of components may differ from that shown in FIGS. 2-4. Thus, there may be additional components, fewer components, different components, differently shaped components, differently sized components, and/or the like.

FIGS. 5-6 illustrate the first front locking mechanism 146-1. FIG. 5 illustrates the first front locking mechanism 146-1 in an unlocked configuration. FIG. 6 illustrates the first front locking mechanism 146-1 in a locked configuration. It should be understood that the description to follow also applies to the second front locking mechanism 146-2.

The first front locking mechanism 146-1 includes a latch 502 and a front locking member 504. The latch 502 includes a first end 506, a second end 508, and a pivot pin 510 located therebetween. The latch 502 is pivotable about the pivot pin 510 between a release position shown in FIG. 5 and a latched position shown in FIG. 6. The first end 506, which is arranged within the receptacle 410 of the first mounting block 134-1, is configured as a flat plate that is sized to fit within the slot 408 that is formed in the distal end portion 402 of the mounting arm 204. The first end 506 also includes a slot 512 that is configured to receive the lower pin 406 of the distal end portion 402 of the mounting arm 204.

With the above described exemplary arrangement, during installation of the first guard 132-1 on the industrial meat grinder 100, as the mounting arm 204 is lowered into the receptacle 410, if the first guard 132-1 is rotated away even slightly away from the head 114, the slot 408 on the mounting arm 204 will not be aligned with the first end 506 of the latch 502, which will prevent the mounting arm 204 from becoming fully seated within the first mounting block 134-1. However, as the first guard 132-1 is rotated such that the shielding component 202 is positioned to cover the head 114, the slot 408 moves into alignment with the first end 506 of the latch 502, thereby allowing the mounting arm 204 to drop further downwardly into the receptacle 410. As the mounting arm 204 moves downwardly, the lower pin 406 is received by the slot 512 in the first end 506 of the latch 502 and causes the latch 502 to pivot about the pivot pin 510 toward the latched position shown in FIG. 6. Downward movement of the mounting arm 204 continues until the upper protrusion 208 becomes seated within the upper notch 212 of the first mounting block 134-1, which limits further downward movement of the mounting arm 204. The latch 502 and the mounting arm 204 are configured such that when the upper protrusion 208 becomes seated within the upper notch 212, the second end 508 of the latch 502 is positioned adjacent to the front locking member 504, as shown in FIG. 6.

The second end 508 of the latch 502, which is arranged inside the housing 138, includes a component 514, which may be magnetic or ferromagnetic, that is configured to engage the front locking member 504. The pivot pin 510 extends through a wall 516 of the first mounting block 134-1 and allows the latch 502 to move between the release position (shown in FIG. 5) and the latched position (shown in FIG. 6). When the latch 502 is in the release position, the slot 512 has a substantially vertical orientation that allows the lower pin 406 to be inserted into and removed therefrom. When the latch 502 is in the latched position, the slot 512 has a substantially horizontal orientation that retains the lower pin 406 therein and inhibits both rotation of the mounting arm 204 and removal of the mounting arm 204 from the receptacle 410 of the first mounting block 134-1.

The front locking member 504 includes a proximity sensor 518 and an electromagnet 520. The proximity sensor 518 is configured to detect when the component 514 of the latch 502 is adjacent to the electromagnet 520 (and accordingly, when the latch 502 is in the latched position). The proximity sensor 518 may be in electrical communication with other components of the industrial meat grinder 100 interlock system such that prime mover 140 cannot be energized unless the proximity sensor 518 indicates that the latch 502 is in the latched position. The electromagnet 520 is a component that may be selectively energized with an electric current (e.g., via the mode switch 108) to generate a magnetic field that attracts and secures the component 514 of the latch 502 into close proximity or contact with the electromagnet 520. Accordingly, when the electromagnet 520 is energized and the latch 502 is in latched position, the first front locking mechanism 146-1 is in the locked configuration and the first guard 132-1 is secured in the closed position. When the electromagnet 520 is de-energized, for example after changing the mode switch 108 to the OFF state and the interlock sensor 144 detecting no movement inside the industrial meat grinder 100, the first front locking mechanism 146-1 transitions to the unlocked configuration and the mounting arm 204 may be lifted out of the receptacle 410 to also place the latch 502 in the release state.

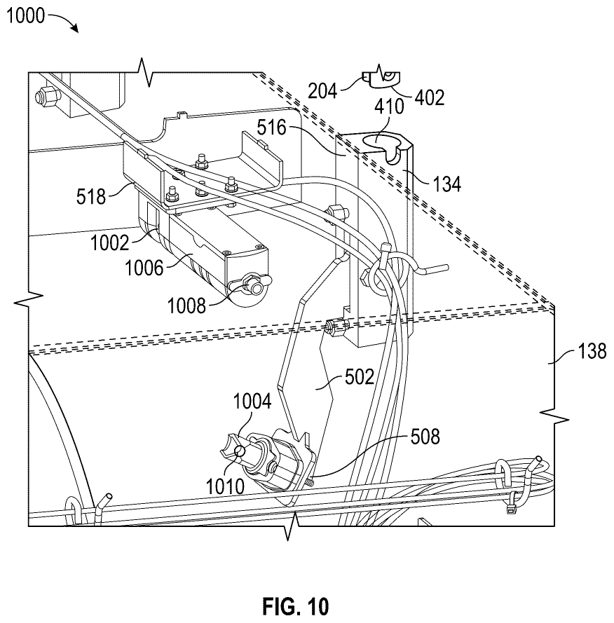

As indicated above, FIGS. 5-6 are provided as an example. Other examples may differ from what is described with regard to FIGS. 5-6. For example, the number and arrangement of components may differ from that shown in FIGS. 5-6. Thus, there may be additional components, fewer components, different components, differently shaped components, differently sized components, and/or the like. In some exemplary alternate configurations, the electromagnetic locking member 504 may be replaced with a pin-style locking member that includes an actuator that is operable to insert or withdraw a locking pin through a hole or other aperture provided in the latch 502. For example, as illustrated in FIG. 10, the electromagnetic locking member 504 and the magnetic component 514 may be respectively replaced with a solenoid latching component and a receptacle. In other alternate configurations, the latch 502 may include a pin that extends through an opening in the front locking member 504 when the latch 502 is in the latched position, and the front locking member 504 may include a locking mechanism that engages the pin to secure the latch in the latched position. In still other alternate configurations, a pawl and ratchet mechanism may be employed whereby engagement of the pawl with the ratchet prevents rotation of the latch 502 away from the latched position until an actuator or other mechanism disengages the pawl from the ratchet.

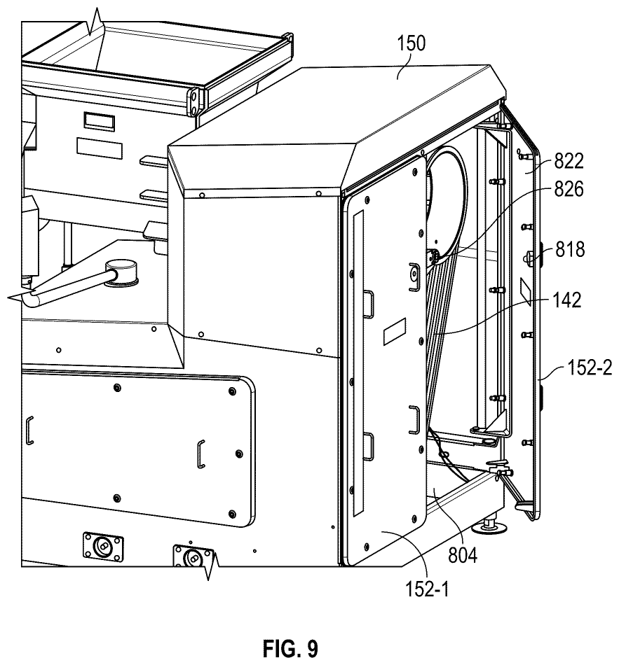

FIGS. 7-9 illustrate the pair of rear doors 152 hingedly connected to a rear panel 702 of the frame 150. FIG. 7 illustrates the first rear door 152-1 and the second rear door 152-2 both in closed positions. FIG. 8 illustrates the first rear door 152-1 and the second rear door 152-2 both in open positions, and the first rear locking mechanism 148-1 and the second rear locking mechanism 148-2 both in unlocked configurations. FIG. 9 illustrates the first rear door 152-1 in a closed position, the second rear door 152-2 in an open position, the first rear locking mechanism 148-1 in a locked configuration, and the second rear locking mechanism 148-2 in an unlocked configuration.

The rear panel 702 of the frame 150 includes a first panel opening 802 that is configured to be covered by the first rear door 152-1, a second panel opening 804 that is configured to be covered by the second rear door 152-2, and a frame element 806 that separates the first panel opening 802 from the second panel opening 804.

The first rear locking mechanism 148-1 includes a first rear element 808 and a first rear locking member 810. The first rear element 808, which may be magnetic or ferromagnetic, is attached to a first surface 812 of the first rear door 152-1, and is aligned with the first rear locking member 810. The first rear locking member 810, which includes a first rear proximity sensor 814 and a first rear electromagnet 816, is attached to the frame element 806 and is arranged within the first panel opening 802.

The second rear locking mechanism 148-1 likewise includes second rear element 818 and a second rear locking member 820. The second rear element 818, which may be magnetic or ferromagnetic, is attached to a second surface 822 of the second rear door 152-2, and is aligned with the second rear locking member 820. The second rear locking member 820, which includes a second rear proximity sensor 824 and a second rear electromagnet 826, is attached to the frame element 806 and is arranged within the second panel opening 804.

In the description that follows, the functionality of the first rear locking mechanism 148-1 will be described. It should be understood that the description equally applies to the second rear locking mechanism 148-2.

The first rear proximity sensor 814 is configured to detect when the first rear element 808 is adjacent to the first rear electromagnet 816 (and accordingly, when the first rear door 152-1 is in the closed position). The first rear electromagnet 816 is a component that may be energized with an electric current (e.g., via the mode switch 108) to generate a magnetic field that locks the first rear element 808 in contact with the first rear electromagnet 816. Accordingly, when the first rear electromagnet 816 is energized, the first rear locking mechanism 148-1 is in the locked configuration and the first rear door 152-1 may not be opened. When the first rear electromagnet 816 is de-energized (e.g., after changing the mode switch 108 to the OFF state and the interlock sensor 144 detecting no movement inside the industrial meat grinder 100), the first rear locking mechanism 148-1 is in the unlocked configuration and the first rear door 152-1 may be opened.

As indicated above, FIGS. 7-9 are provided as an example. Other examples may differ from what is described with regard to FIGS. 7-9. For example, the number and arrangement of components may differ from that shown in FIGS. 7-9. Thus, there may be additional components, fewer components, different components, differently shaped components, differently sized components, and/or the like.

In some configurations, the front locking members 504, the first rear locking member 810, and the second rear locking member 820 may each be or include an electromagnetic RFID safety locking switch, such as one of the MGL range of safety switches available from IDEM Safety Switches USA Inc.

FIG. 10 illustrates an example front locking mechanism 1000, which may be utilized in place of the front locking mechanism 146. The front locking mechanism 1000 includes the latch 502, a first locking member 1002, and a second locking member 1004. As described above in connection with FIG. 5, the latch 502 includes the first end 506, the second end 508, and the pivot pin 510 located therebetween. The latch 502 is pivotable about the pivot pin 510 between a release position (shown in FIG. 10) and a latched position. The first end 506, which is arranged within the receptacle 410 of the mounting block 134, is sized to fit within the slot 408 that is formed in the distal end portion 402 of the mounting arm 204, as described above.

As the mounting arm 204 moves downwardly, the lower pin 406 of the distal end portion 402 of the mounting arm 204 is received by the slot 512 in the first end 506 of the latch 502, causing the latch 502 to pivot about the pivot pin 510 toward the latched position. Downward movement of the mounting arm 204 continues until the upper protrusion 208 becomes seated within the upper notch 212 of the mounting block 134, which limits further downward movement of the mounting arm 204. The latch 502 and the mounting arm 204 are configured such that when the upper protrusion 208 becomes seated within the upper notch 212, the second end 508 of the latch 502 is positioned adjacent to the first locking member 1002.

The second end 508 of the latch 502, which is arranged inside the housing 138, supports a the second locking member 1004, which is a receptacle that is configured to engage the first locking member 1002. The pivot pin 510 extends through the wall 516 of the mounting block 134 and allows the latch 502 to move between the release position (shown in FIG. 10) and the latched position. When the latch 502 is in the release position, the slot 512 has a substantially vertical orientation that allows the lower pin 406 to be inserted into and removed therefrom. When the latch 502 is in the latched position, the slot 512 has a substantially horizontal orientation that retains the lower pin 406 therein and inhibits both rotation of the mounting arm 204 and removal of the mounting arm 204 from the receptacle 410 of the mounting block 134.

The first locking member 1002, in this example, includes a solenoid component 1006. The solenoid component 1006 is an electromechanical device that uses electromagnetic force to move a plunger 1008 into an outer position, where the plunger 1008 may remain without continuous electrical power. When the plunger 1008 is in the outer position, the plunger 1008 may be configured to engage an opening 1010 in the second locking member 1004, thereby maintaining the latch 502 in the latched position. Accordingly, when the solenoid component 1006 is energized (e.g., via the mode switch 108) and the latch 502 is in latched position, the front locking mechanism 1000 is in the locked configuration and the guard 132 is secured in the closed position. When the solenoid component 1006 is de-energized, for example after changing the mode switch 108 to the OFF state and the interlock sensor 144 detecting no movement inside the industrial meat grinder 100, the front locking mechanism 1000 transitions to the unlocked configuration and the mounting arm 204 may be lifted out of the receptacle 410 to also place the latch 502 in the release state.

In some implementations, the first locking member 1002 may further include the proximity sensor 518, which is configured to detect when the second locking member 1004 is adjacent to the solenoid component 1006 (and accordingly, when the latch 502 is in the latched position). The proximity sensor 518 may be in electrical communication with other components of the industrial meat grinder 100 interlock system such that prime mover 140 cannot be energized unless the proximity sensor 518 indicates that the latch 502 is in the latched position.

As indicated above, FIG. 10 is provided as an example. Other examples may differ from what is described with regard to FIG. 10. For example, the number and arrangement of components may differ from that shown in FIG. 10. Thus, there may be additional components, fewer components, different components, differently shaped components, differently sized components, and/or the like. Furthermore, it should be understood that the second locking member 1004 and the solenoid component 1006 may be used in place of the first rear element 808 and the first rear electromagnet 816, respectively, and/or in place of the second rear element 818 and the second rear electromagnet 826.

With the above described configuration, the interlock circuitry of the industrial meat grinder 100 or other industrial machinery to which the present disclosure may be applied may be configured in the following exemplary manner: To activate the prime mover 140, the mode switch 108 should be in the ON state, the interlock sensor 144 should be providing a signal corresponding to no motion of grinder components, the pair of front locking mechanisms 146, 1000 should be providing a signal corresponding to the latches 502 being in the latched position, and the pair of rear locking mechanisms 148 should be providing a signal corresponding to the rear doors 152 being in the closed position. If the foregoing conditions, as well as other conditions based on a particular application, are true, then the prime mover 140 may be activated. Upon activation of the prime mover 140, signals may be sent to the pair of front locking mechanisms 146, 1000 and the pair of rear locking mechanisms 148 to activate their respective electromagnets, solenoid latching components, or other locking structure (e.g. locking pin, pawl, and/or the like) to thereby place the pair of front locking mechanisms 146, 1000 and the rear locking mechanisms 148 into their respective locked configuration, which, in the illustrated example, in turn prevents removal of the pair of guards 132 and opening of the pair of rear doors 152. If a guard 132 is forcibly removed or a rear door 152 is forced open, the respective front locking mechanism 146, 1000 or rear locking mechanism 148 may send a signal to the interlock circuitry to shut down the prime mover 140. The interlock circuitry may also generate a warning message to alert an operator that a certain operating protocol is no longer being met.

To stop the machinery, the mode switch 108 may be operated to change from the ON state to the OFF state. Upon receipt of such a signal from the mode switch 108, the interlock circuitry may nonetheless maintain the front locking mechanisms 146, 1000 and rear locking mechanisms 148 in their respective locked configurations until the interlock sensor 144 provides a signal that indicates no further movement of the prime mover 140 or other moveable components is detected. Upon receipt of such signal from the interlock sensor 144, the interlock circuitry may send signals to the front locking mechanisms 146, 1000 and rear locking mechanisms 148 instructing them to deactivate their respective electromagnets, solenoid latching components, or other locking structure to thereby allow opening of the rear doors 152 and removal of the guards 132.

As uses herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A safety interlock system for industrial machinery, the system comprising:
a prime mover operable to provide rotational driving force;
a working member driven by the prime mover;
a guard assembly moveable between a closed position, in which the guard assembly at least partially covers the working member, and an open position that affords access to the working member;
a latch engageable with the guard assembly and moveable between a latched position that secures the guard assembly in the closed position and a release position that affords movement of the guard assembly toward the open position;
a locking member engageable with the latch, the locking member having a locked configuration that secures the latch in the latched position, and an unlocked configuration that affords movement of the latch from the latched position toward the release position;
a mode switch operable to control the prime mover between an ON state and an OFF state; and
an interlock sensor operable to detect movement of at least one of the prime mover and the working member, wherein regardless of whether the prime mover is in the ON state or the OFF state, the interlock sensor prevents the locking member from changing state from the locked configuration to the unlocked configuration when movement of at least one of the prime mover and the working member is detected.

2. The safety interlock system of claim 1, wherein the prime mover includes an electric motor, and the working member includes at least one of a feedscrew and a blade.

3. The safety interlock system of claim 1, wherein the latch includes a first end engageable with the guard assembly, a second end engageable with the locking member, and a pivot axis about which the latch is pivotable between the latched position and the release position.

4. The safety interlock system of claim 3, wherein the guard assembly includes a mounting arm having a pin extending transversely therethrough, wherein the first end includes a slot that is sized to receive the pin, wherein upon movement of the guard assembly from the open position toward the closed position the pin engages the slot and urges the latch from the release position toward the latched position.

5. The safety interlock system of claim 4, wherein engagement of the pin with the slot limits rotational movement of the guard assembly about the mounting arm to at least partially secure the guard assembly in the closed position.

6. The safety interlock system of claim 4, wherein when the guard assembly is in the closed position, the latch is in the latched position, and the locking member is in the locked configuration, the locking member prevents pivotal movement of the latch about the pivot axis.

7. The safety interlock system of claim 1, wherein the locking member includes one of an electromagnet and a solenoid component, and wherein, when the locking member is in the locked configuration, the locking member energizes the at least one of the electromagnet and the solenoid component to secure the latch in the latched position.

8. The safety interlock system of claim 1, wherein the prime mover, the latch, and the locking member are contained within a housing.

9. A safety interlock system for industrial machinery, the safety interlock system comprising:
a prime mover operable to provide rotational driving force;
a working member driven by the prime mover;
a guard assembly moveable between a closed position, in which the guard assembly at least partially covers the working member, and an open position that affords access to the working member;
a mode switch operable to control the prime mover between an ON state and an OFF state; and
an interlock sensor operable to detect movement of at least one of the prime mover and the working member, wherein regardless of whether the prime mover is in the ON state or the OFF state, the interlock sensor prevents movement of the guard assembly away from the closed position when movement of at least one of the prime mover and the working member is detected.

10. The safety interlock system of claim 9, wherein the prime mover includes an electric motor, and the interlock sensor includes a current sensor in electrical communication with the electric motor, wherein the current sensor is operable to sense induced electrical current resulting from rotational movement of the electric motor after the electric motor has been changed from the ON state to the OFF state.

11. The safety interlock system of claim 9, wherein the working member includes at least one of a feedscrew and a blade.

12. The safety interlock system of claim 9, wherein the interlock sensor includes a rotary sensor that is operable to sense rotational movement of at least one component of at least one of the prime mover and the working member.

13. The safety interlock system of claim 9, further comprising a housing that contains the prime mover and isolates the prime mover from the working member and the guard assembly.

14. The safety interlock system of claim 13, wherein the guard assembly includes:
a pair of guards, each guard including:
a shielding component that is configured to at least partially cover the working member, and
a mounting arm that supports the shielding component; and
a pair of mounting blocks attached to the housing, each mounting block including a receptacle to receive a distal end of a respective mounting arm.

15. The safety interlock system of claim 14, further comprising a pair of locking mechanisms, each locking mechanism including a latch that is configured to engage the distal end of the respective mounting arm to secure the guard assembly in the closed position.

16. A safety interlock system for industrial machinery, the safety interlock system comprising:
a prime mover operable to provide rotational driving force;
a working member driven by the prime mover;
a guard assembly moveable between a closed position, in which the guard assembly inhibits access to the working member, and an open position that affords access to the working member;
a latch engageable with the guard assembly and moveable between a latched position that secures the guard assembly in the closed position, and a release position that affords movement of the guard assembly toward the open position; and
an interlock sensor operable to detect movement of at least one of the prime mover and the working member, wherein the interlock sensor prevents the guard assembly from moving to the open position when movement of at least one of the prime mover and the working member is detected.

17. The safety interlock system of claim 16, further comprising:
a mode switch operable to control the prime mover between an ON state and an OFF state,
wherein the interlock sensor is configured to prevent the guard assembly from moving to the open position when movement of the at least one of the prime mover and the working member is detected, regardless of whether the prime mover is in the ON state or the OFF state.

18. The safety interlock system of claim 16, wherein the prime mover is an electric motor, and the working member is a feedscrew.

19. The safety interlock system of claim 16, wherein the guard assembly includes a mounting arm having a pin extending transversely therethrough; and
wherein the latch includes:
a first end engageable with the guard assembly and including a slot that is sized to receive the pin, and
a second end opposite the first end,
wherein upon movement of the guard assembly from the open position toward the closed position, the pin engages the slot and urges the latch from the release position toward the latched position.

20. The safety interlock system of claim 19, further comprising a locking member engageable with the second end of the latch, the locking member having a locked configuration that secures the latch in the latched position, and an unlocked configuration that affords movement of the latch from the latched position toward the release position.
